(19) United States
(12) Patent Application Publication
(10) Pub. No.: US 2013/0008373 A1
(43) Pub. Date: Jan. 10, 2013

(54) ROD BED LOCKING SYSTEMS

(75) Inventor: Ari Rousu, Greenwell Springs, LA (US)

(73) Assignee: BTG IPI, LLC, De Pere, WI (US)

(21) Appl. No.: 13/518,191

(22) PCT Filed: Dec. 15, 2010
(86) PCT No.: PCT/EP2010/069751

§ 371 Date: Sep. 21, 2012

Related U.S. Application Data
(60) Provisional application No. 61/289,137, filed on Dec. 22, 2009.

(30) Foreign Application Priority Data
Feb. 3, 2010 (EP) 10152512.9

(51) Int. Cl. B05C 1/08; B05B 12/14

(52) U.S. Cl. 118/258; 248/214

(57) ABSTRACT

A metering device, including a holder and an insert, for coating liquid or viscous coating medium onto a moving material web. The holder being elongated and mountable to a frame and comprising an insert groove in the longitudinal direction, adapted to receive an insert, and an engagement formation in the longitudinal direction along the insert groove. The insert being elongated and comprising a rod groove in the longitudinal direction, being adapted to rotatably support a coating rod having a circular cross section and being designed to surround the coating rod over more than 180° of its circumference, and an engagement formation in the longitudinal direction along the rod groove. The engagement formations of the holder and the insert are designed to interact with a locking member to allow interconnection between the insert and the holder of the metering device.

### TECHNICAL FIELD

The present invention relates to a metering device for coating liquid or viscous coating medium onto a moving material web, comprising

an elongated holder being mountable to a frame and being provided with an insert groove in the longitudinal direction as well as an engagement formation in the longitudinal direction along the insert groove,

an elongated insert being mountable into the insert groove and being provided with a rod groove in the longitudinal direction, which is adapted to rotatably support a coating rod having a circular cross section, as well as an engagement formation in the longitudinal direction along the rod groove, wherein the rod groove of the insert is designed to surround the coating rod over more than 180° of its circumference,

and at least one locking member adapted to interact with the engagement formation of the holder and the engagement formation of the insert to achieve interconnection between the holder and the insert.

The invention also relates to a holder unit, a holder, an insert unit and an insert for such a metering device.

### BACKGROUND OF THE INVENTION

Metering devices for coating liquid or viscous coating mediums onto a moving web, either directly or indirectly via a transfer roll, are well known in the art. Especially within the paper manufacturing industry where paper webs often are coated with colouring substances, sizing agents and the like. The coating medium may optionally be applied directly onto the moving web or be applied to a transfer roller, which in its turn transfers the coating medium onto the web. The coating medium is supplied by means of some kind of coating feeder, which applies the coating medium to the web or to the transfer roller. The metering device is positioned downstream from the coating feeder as seen in the direction of the moving web and/or the transfer roller and meters the coating layer by means of a rotating cylindrical coating rod, which is supported in the metering device and which is pressed with a force towards the web/transfer roller. By regulating the pressing force of the coating rod towards the web/transfer roller, it is possible to control the thickness of the coated layer.

In a most common design of a metering device, the coating rod is installed directly into a supporting holder which is attached to some kind of framework. However, the rotating action of the coating rod causes wear of the coating rod and the circular shaped bed or groove for the coating rod in the holder. This causes need for frequent replacement of the coating rod and the holder and since the holder is a supporting structure having a rather large overall size, the costs for each such replacement will be quite high. In order to reduce costs, a type of metering device has been developed in which the coating rod is rotatably accommodated in a rod groove of an insert, and the insert is in its turn accommodated in an insert groove in a holder. In this way it is possible to manufacture the coating rod and the insert, which are parts exposed to heavy wear due to the rotating operation, with rather small dimensions which will make them comparatively inexpensive to manufacture and replace. The holder, on the other hand, is not exposed to the same wear as the insert unit, i.e. the coating rod and the insert, and is accordingly dimensioned to firmly support the insert and coating rod in a well-defined position and adapted to last essentially the lifetime of the metering device.

One problem with a metering device of this kind is how to attach the insert unit in the holder since the insert has to surround the coating rod over more than 180° of its circumference and the holder must be able to hold the insert unit in a reliable way. One way to achieve this would be to slide the insert unit from one end into the insert groove in the holder. However, since a metering device of this kind has a considerable length, sometimes up to 10-12 m, such a procedure would require a lot of space and also a lot of force due to friction between the insert and the insert groove since the insert must be accommodated with rather close fit in the holder to ensure a well-defined positioning without flexing or vibrations of the coating rod for achieving a sufficient precision when applying the coating layer.

In prior art it is known to make the insert somewhat elastic such that the rod groove in the insert can be opened up a bit and the coating rod inserted sideways into the rod groove of the insert. Also, the holder is made some-what elastic, by means of a weakening portion or the like, such that the insert groove in the holder can be slightly opened up and also the insert unit can be inserted sideways into the insert groove of the holder. In order to ensure firm attachment of the insert unit in the insert groove of the holder, a compressed-air hose is arranged in the holder which, when supplied with compressed air, will act on the holder to close the insert groove around the insert unit. Such metering devices are disclosed in for example WO 03/078077 and WO 05/033407. One disadvantage with such a structure is that it has a built in weakness in its structure and is therefore totally dependent on supply of compressed air. Accordingly, in case of failure of the compressed air supply, the insert unit can accidentally be detached from the holder.

In WO 07/063183 is disclosed a metering device in which the holder is made of a rigid material and has no weakening portion to allow open up of the insert groove. In order to be able to install the insert into the insert groove of the holder, the coating rod has to be removed from the insert such that the insert can be compressed and accommodated in the insert groove. To subsequently allow insertion of the coating rod into the rod groove, the insert has to be made of a resilient material such that it can be deformed when pushing the coating rod into the rod groove. Such a metering device can advantageously dispense with any compressed-air hose. However, the resilient properties of the insert could affect the positioning precision for the coating rod in an unfavourable way. Also, to push a very long coating rod of several meters of length into a narrow rod groove by hand may cause difficulties. Moreover, the attachment is probably not so reliable since a force of the same size but in the opposite direction, could accidentally release the coating rod from the rod groove again.

Also other types of metering devices are known in prior art. As examples can be mentioned a type where the insert is attached to the holder by means of a T-formed or wedge-formed strip of the holder which is inserted into a mating groove in the insert by sliding the insert sideways. One disadvantage with such a solution is that a play inevitable appears in such a structure which might deteriorate the well-defined positioning of the coating rod. Also, since the insert is not enclosed by the holder this must be compensated by making the insert correspondingly more rigid with increased costs as a consequence.

### SUMMARY OF THE INVENTION

It is an object of the invention to provide an improved metering device according to the introduction. More precisely, it is an object to provide a holder, a holder unit, an insert and an insert unit for such a metering device by which a reliable attachment of an insert and an insert unit, including an insert and a coating rod, to the metering device is facilitated. At least this object is achieved by a holder unit according to claim 1, a holder according to claim 7, an insert unit according to claim 12 and an insert according to claim 16.

The invention also relates to a metering device having essentially the same object as above. This object is achieved by a metering device according to the claims 20-23.

Accordingly, the basis of the invention is the insight that this object may be achieved by providing at least one locking member as well as an engagement formation along an insert groove of the holder and an engagement formation along a rod groove of the insert, respectively, wherein the locking member is adapted to interact with the engagement formation of the holder and the engagement formation of the insert to connect the holder and the insert to each other. Moreover, the locking member is a separate component, which is detachable from or connected by means of a pivot joint to the holder.

It is to be understood that the definition in some of the claims that the invention relates to a metering device for coating liquid or viscous coating medium onto a moving material web, should be interpreted extensively and means that the coating medium either can be coated directly onto a moving material web or indirectly via a transfer roller or a transfer belt, which in its turn transfers the coating medium onto the moving material web.

Within this overall idea the invention can be realized in many different ways. The locking member is intended to be formed as a separate component, which can be completely detached from the holder and the insert or, as is the case in two of the three embodiments hereinafter described and illustrated, connected to the holder by means of a pivot joint.

The locking member may be of a snap-in type, which may assume a locking position by applying a force in a first direction, such that the structure of the locking member passes a dead-centre position and the locking member maintains the locking position until a force in an opposite direction brings the locking member back to a releasing stage. By a locking member designed in this way it can be avoided to have to be dependant of an external force, such as a force from hydraulic and pneumatic pressure as is disclosed in some of the prior art documents mentioned hereinbefore, which has to act constantly onto the locking member in order to hold the insert and the coating rod in position. Such a snap-in locking member relies on elastic deformation of the material in at least some part of the locking member and/or the engagement portion of the holder and/or the insert to be able to pass the dead-centre position and tighten the holder and the insert towards each other in the locking position.

In a hereinafter described first embodiment of the present invention, the locking member is formed with a link member, which at one edge is rotatably connected to the holder and at the other edge rotatably connected along one edge of the locking member. At the other edge the locking member is formed with a hook shaped portion, which is adapted to go into engagement with the engagement formation in the insert. The link member defines a dead-centre position for the locking member such that when the hook shaped portion is in engagement with the engagement formation of the insert and the rotatable connection to the locking member is at one side of the dead-centre position, the locking member locks the insert to the holder, whereas when the rotatable connection to the locking member is at the other side of the dead-centre position, the insert is released. Such a locking member is sometimes also referred to as a dog-bone mechanism or a dual pivoting mechanism.

In a hereinafter described and illustrated second embodiment, the locking member is formed as a hook member, which along one edge is connected by means of a pivot joint to the holder and, by means of a hook portion along the other edge, grips over an engagement formation in the insert. Accordingly, in this embodiment the engagement formation in the holder is the pivot joint.

In a third embodiment the locking member is in form of a clamping member, which grips over the upper edges of each of the holder and the insert. Accordingly the locking member in this embodiment can be completely removed from the metering device during replacement of the insert and the coating rod.

In all three of the embodiments described and illustrated hereinafter, the metering device is provided with a locking mechanism between the upper edges of the insert and the holder. A similar locking member could, in an alternative embodiment, be arranged also at the lower edges of the insert and the insert groove of the holder as in their upper edges. However, in the described and illustrated embodiments, the lower edges of the insert and the holder are interconnected by means of an engagement formation within the insert groove of the holder and an engagement formation on the outside of the insert, which are shaped to be able to be engaged with or released from each other when the insert is somewhat angled in relation to its fully inserted position in the holder. From this position the insert can be rotated around the lower engagement formations to the fully inserted position in the holder, in which position the lower engagement formations will interlock the lower edges of the insert and the holder to each other, and then the locking mechanism can be operated to interlock the upper edges of the insert and the holder to each other. It is to be understood however, that many other engagement means shaped in different ways also could be conceivable within the scope of the invention.

A locking member being attached to the metering device by means of a pivot joint, according to the hereinafter described first and second embodiments, is normally attached to the holder. However, it is to be understood that the locking member also could be attached to the insert though this is not preferred since it will have to effect that the costs for the insert will increase, which is one of the components of the metering device that frequently has to be replaced. It is also to be understood that the insert and the holder can be interconnected by means of one elongated locking member, which extends essentially the whole length of the metering device. However, it is also conceivable that the locking member is divided into several separate locking member parts positioned with a distance from each other.

In a favourable embodiment of the invention, the insert and the coating rod is marketed as an assembled insert unit such that the user only need to install the insert unit into the metering device and accordingly does not have to assemble the insert and the coating rod to each other before installing them into the metering device. By assembling the insert and the coating rod already at a manufacturing plant, additional opportunities are presented for designing especially the insert, since more advanced methods for assembling the insert and coating rod can be practiced at a manufacturing plant than at a production plant for producing e.g. coated paper. For example it would be possible to manufacture the insert of a more rigid material and to slide the coating rod into the rod groove from one end of the insert, which probably could be easier to perform at the manufacturing plant than at the user.

It is to be understood that the coating rod either can be driven, preferably in an opposite direction in relation to the moving web or transfer roller, or be formed as an idle roller which rotates with the moving web or transfer roller by being pressed towards the same. Moreover, according to the disclosed and illustrated embodiments, the insert is provided with two water lubricating channels inside the rod groove for the purpose of providing lubrication for the rotating coating rod and also for cleaning of the rod groove from coating medium. This is an improvement over existing disclosed inserts, in which only one single water lubrication channel is provided.

The invention provides an improved metering device, a holder, a holder unit, an insert and an insert unit, by which it is possible to use a strong and sustainable holder without any built in weaknesses and which provides a reliable mechanical locking mechanism for interconnecting the holder and the insert without having to rely on any constant external force to act on the locking member to interconnect the holder and the insert. Moreover, the insert has, in a preferred embodiment, sufficient dimensions to accommodate at least two lubricating water channels such that sufficient lubrication and cooling of the rotating coating rod can be achieved. It is to be understood, however, that any number of water channels can be provided and in some applications no water channels are provided at all.

### BRIEF DESCRIPTION OF THE DRAWINGS

The invention will hereinafter be described in detail by reference to the accompanying drawings in which possible embodiments are illustrated by way of example. It is to be understood, however, that many other embodiments are conceivable within the scope of the claims. In the drawings:

FIG. 1 is a schematic cross sectional view of a coating feeder and a metering device according to the invention during coating of viscous coating medium directly onto a moving web;

FIG. 2 is a schematic cross sectional view of a coating feeder and a metering device according to the invention during coating of viscous coating medium indirectly onto a moving web via a transfer roller;

FIGS. 3-6 are cross sectional views through an embodiment of a metering device according to the invention in different stages for installing/releasing of an insert unit, comprising an insert and a rotatable rod;

FIG. 7-9 are perspective views of a portion of a metering device disclosing different arrangements of a holder and a locking member along the length of an insert unit; and

FIGS. 10-11 are cross sectional views through a metering device according to two alternative embodiments.

### DETAILED DESCRIPTION OF EMBODIMENTS OF THE INVENTION

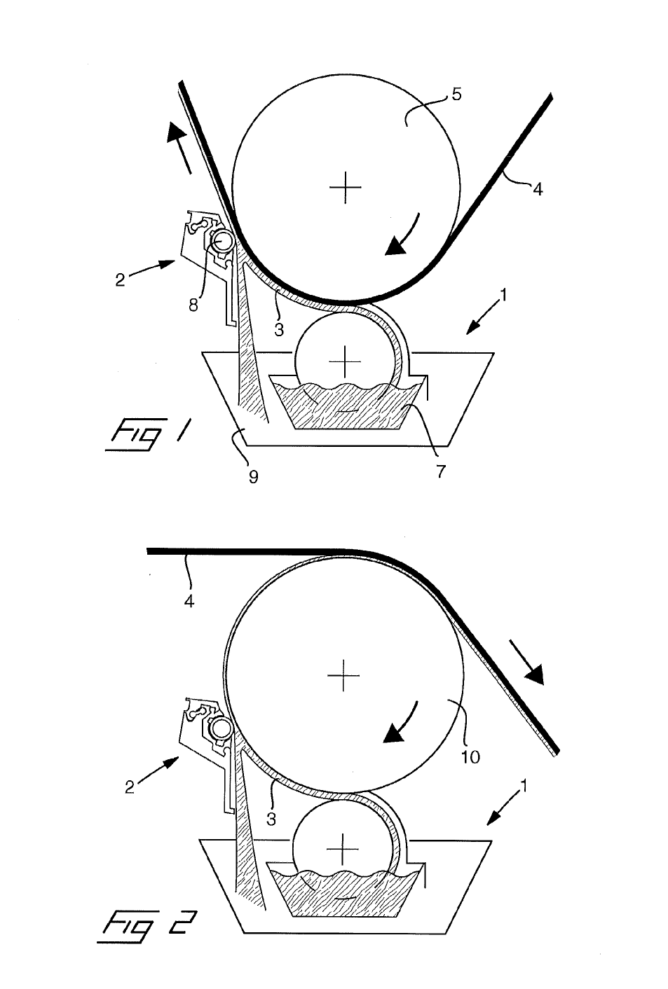

Reference is first made to FIG. 1 in which is schematically illustrated a conceivable arrangement of a coating feeder 1 and a metering device 2, according to the invention, for coating a liquid or viscous coating medium 3 onto a moving web 4, e.g. a paper web. In the illustrated section the web is guided around a rotating web roller 5. The coating feeder is located beneath the web roller and comprises a rotating coating roller 6, which is pressed towards the web roller and of which a lower part is immersed into a coating medium within an inner trough 7. Downstream of the coating roller, as seen in the direction of the moving web roller, the metering device is arranged with a rotating, cylindrical coating rod 8, which is pressed against the web and the web roller. During operation, the coating roller collects coating medium from the inner trough and applies it onto the moving web on the web roller. The amount of coating medium that is applied onto the moving web may be in the order of about 10 to 20 times as much as is desired on the completed web. For this reason the metering device is arranged downstream of the coating feeder to meter the thickness of the layer of coating medium. Normally, this is accomplished by rotating the coating rod in an opposite direction in relation to the moving web. However, it is also possible to let the coating rod rotate with the moving web, as an idle rod, by simply press the coating rod towards the moving web and the web roller. In the latter case, the surface of the coating rod could be patterned, wherein the depth of the pattern as well as the design of the pattern determine the resulting thickness of the layer. The excess coating medium flows from the metering device into an outer trough 9 and can subsequently be recycled into the inner trough. It is to be understood that FIG. 1 is merely a schematic illustration and that the arrangement in reality comprises additional equipment such as for example supporting structures for each of the web roller, the coating feeder and the metering device.

In FIG. 2 is illustrated an alternative application of the coating feeder 1 and the metering device 2. Here the coating medium 3 is applied by means of the coating feeder and metered by means of the metering device on a transfer roller 10. The metered layer of coating medium on the transfer roller is subsequently transferred to the moving web 4, which runs over a portion of the transfer roller 10.

Reference is then made to FIGS. 3-6 for a detailed description of a first embodiment of a metering device according to the invention. The metering device comprises a holder 11, a locking member 12 mounted on the holder and an insert unit 13 composed of an insert 14 and the coating rod 8. The holder has a robust design with a discharge flange 15 in a lower portion, for guiding the excess coating medium downwards into the outer trough, and an insert groove 16 in a lateral position for accommodating the insert unit. The locking member is provided in an upper portion of the holder and one of its edges 17 is hook shaped, as seen in cross section. By means of a link member 18, the locking member is rotatably connected to the holder in an opposite edge portion. The link member is formed as a “dog-bone” as seen in cross section, i.e. has a thickened portion 19 with a substantially circular cross section along each of its edges and a thinner intermediary portion 20. The thickened portions of the link member are each accommodated in a corresponding seating portion 21 at each of the holder and the locking member, respectively, which each is part-circular in cross section and partly surrounds and holds its respective thickened portion in a limited rotatable way.

The insert unit 13 comprises, as already mentioned, an insert 14 and a coating rod 8, which is rotatably supported in a rod groove 22 of the insert, which surrounds the coating rod over more than 180° of its circumference in order to prevent the coating rod from accidentally be released from the insert. To allow mounting of the coating rod into the rod groove, the insert may for example be somewhat resilient to accomplish open up of the rod groove and insertion of the coating rod sideways. It could also be possible to slide the coating rod into the rod groove from one end of the insert. In a preferred embodiment, the insert unit is delivered in an assembled state with the coating rod installed in the insert since these two components are exposed to the same wear and normally need to be replaced at the same time. In this way the replacement can be facilitated for the user.

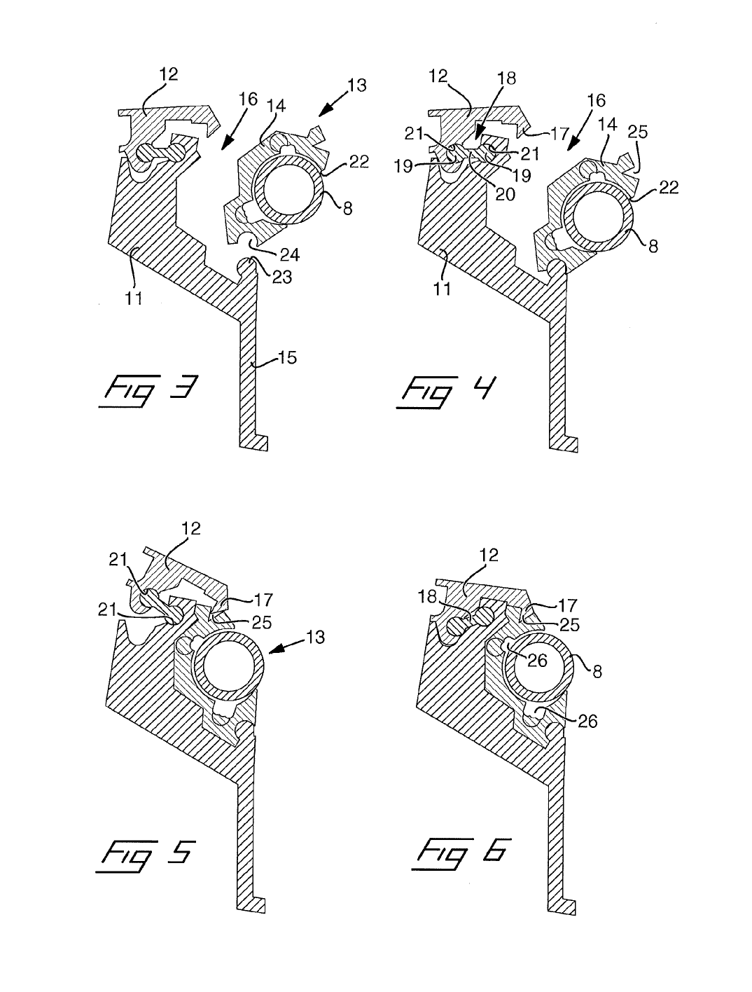

In order to allow mounting of the insert unit 13 and secure attachment in the insert groove 16, the holder 11 is provided with an engagement formation 23 in form of an edge portion having a part circular cross section along the lower portion of the insert groove. The insert is in its turn provided with an engagement formation 24 in form of a groove having a part circular cross section along its lower portion. In this way it is possible to interconnect the lower portions of the insert and the holder by positioning the engagement formation 24 of the insert over the engagement formation 23 of the holder, as is illustrated in FIG. 4, with the insert in a somewhat angled state in relation to its fully inserted position. Subsequently, the insert can be rotated to the fully inserted position, as is illustrated in FIG. 5.

Finally, the locking member 12 is used to accomplish a secure locking of the insert unit in the insert groove. For this reason the insert is provided with an engagement formation 25 in form of a groove in an upper portion along the rod groove. The holder is in its turn, as already mentioned, provided with an engagement formation, in form of the part circular seating portion 21 for the link member 18, in its upper portion along the insert groove. As is illustrated in FIG. 5, the locking member is pivoted around the pivot joints in the seating portions 21 at the holder and the locking member to engage the hook shaped front edge of the locking member in the groove 25 of the insert and subsequently the rear edge of the locking member can be pushed downwards to the locked position as illustrated in FIG. 6. During the movement of the locking member 12 from the position according to FIG. 5 to the position according to FIG. 6, the structure of the locking member will pass a dead-centre position when the plane of the link member 18 is in alignment with the engagement point between the hook shaped edge 17 and the engagement formation 25, i.e. the groove, of the insert. Due to elastic stretching of the material of the locking member when passing the dead-centre position, the locking member will be reliably maintained in the locked position according to FIG. 6.

According to the invention, the insert unit 13 can in a quick and easy way be reliably installed in the metering device 2. Moreover, the insert unit can be released from the metering device in an equal quick and easy way by performing the above described steps in a reverse order.

To achieve lubrication of the rotational movement of the coating rod 8 within the insert 14 and also for cleaning the interface between the coating rod 8 and insert from coating medium, two channels 26 are provided on the inside of the rod groove of the insert. The channels can be connected to a water supply by means of not shown conduits in one or both of the ends of the insert such that the channels are filled with water and a water film is formed in the interface during operation. However, it is to be understood that the insert can also easily be designed to have zero, one, two or more water channels. The number of water channels is dependent on the application and does not always have to be two.

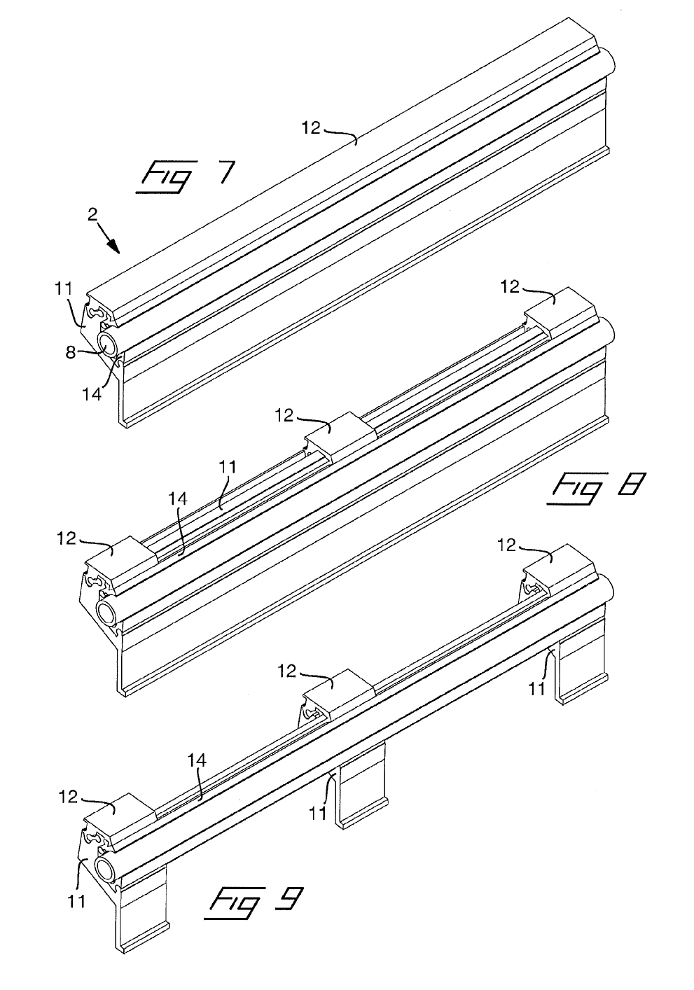

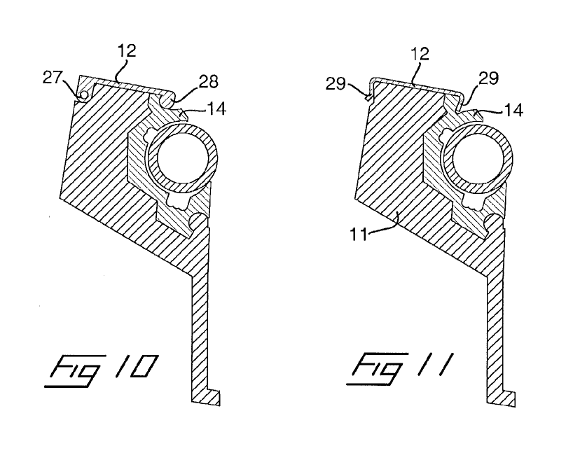

Next, reference is made to FIGS. 7-9, in which are illustrated, in perspective views of a portion of the metering device, three different arrangements of the metering device as illustrated in FIGS. 3-6. In FIG. 7 all of the components, that form part of the metering device, extend over the entire length of the metering device, i.e. the holder 11, the locking member 12, the insert 14 and the coating rod 8. In FIG. 8 on the other hand, the locking member is formed as several short locking member parts 12 distributed on a distance to each other. The advantages with this embodiment are that material is saved and each locking member part will be easier to operate when locking and unlocking the insert unit to the metering device than to operate the elongated locking member in FIG. 7. In FIG. 9, besides the locking member 12, also the holder is formed as several short holder parts 11 distributed on a distance to each other. With this embodiment is achieved an additional saving of material. However, this embodiment requires an insert unit having a sufficient strength and rigidity to be able to operate satisfactory.

Finally, reference is made to FIGS. 10 and 11 in which two alternative embodiments of the locking member 12 are illustrated in cross sectional views through the metering device. In the embodiment according to FIG. 10, the locking member is pivotally connected, by means of a pivot joint 27, to the holder along one edge. Along the other edge, the locking member is formed with a hook-shaped edge 28, which is in engagement with a step-like engagement formation along the rod groove of the insert 13. The step-like engagement formation defines a dead-centre position for the hook-shaped edge, such that the hook-shaped edge has to deform elastically to be able to pass the step-like engagement formation to assume the locking position. The locking member 12 according to FIG. 12 is formed as a separate part which is not connected to the holder by way of a pivot joint or the like. Instead, the locking member is formed as a clamp having a straight portion and two downward/inward angled portions 29, which each grips over a slightly under-cut engagement formation in the holder and the insert, respectively, and in this way interconnects the holder 11 and the insert 14. Here the undercut engagement formations define dead-centre positions for the downward/inward angled portions.

1. A holder unit for a metering device for coating liquid or viscous coating medium onto a moving material web, comprising
an elongated holder being mountable to a frame and being provided with an insert groove in the longitudinal direction as well as an engagement formation in the longitudinal direction along the insert groove,
an elongated insert being mountable into the insert groove and being provided with a rod groove in the longitudinal direction, which is adapted to rotatably support a coating rod having a circular cross section, as well as an engagement formation in the longitudinal direction along the rod groove, wherein the rod groove of the insert is designed to surround the coating rod over more than 180° of its circumference,
and at least one locking member adapted to interact with the engagement formation of the holder and the engagement formation of the insert to achieve interconnection between the holder and the insert, wherein the locking member is a separate component, which is detachable from or connected by means of a pivot joint to the holder.

2. A holder unit according to claim 1, wherein the locking member is of a snap-in type, which may assume a locking position by applying a force in a first direction such that the structure of the locking member passes a dead-centre position and the locking member maintains the locking position until a force in an opposite direction brings the locking member back to a releasing stage.

3. A holder unit according to claim 1, wherein the locking member is formed with a hook shaped portion and the engagement formation of the holder is in form of a pivot joint such that the locking member is pivotally connected to the holder and capable of engaging the engagement formation of the insert by means of the hook shaped portion.

4. A holder unit according to claim 1, wherein the pivot joint comprises a link member, which in one edge is rotatably connected to the holder and in the other edge to the locking member and which defines a dead-centre position for the locking member such that when the hook shaped portion is in engagement with the engagement formation of the insert and the rotatable connection of the locking member is at one side of the dead-centre position, the locking member locks the insert to the holder, whereas when the rotatable connection to the locking member is at the other side of the dead-centre position the insert is releasable from the holder.

5. A holder unit according to claim 1, wherein the holder and the insert are each also provided with a second engagement formation along the opposite edges of the insert groove and the rod groove, respectively, in relation to the locking member, wherein the second engagement formation of the holder and the insert are capable of going into engagement with each other when assembling them in an angled position in relation to the fully mounted position and will interlock these edges to each other when rotating the insert to its fully inserted position in the holder.

6. A holder unit according to claim 1, wherein the insert is at least limitedly resilient to allow opening of the rod groove for allowing insertion of the coating rod into the rod groove.

7. A holder for a metering device for coating liquid or viscous coating medium onto a moving material web, the holder being elongated and mountable to a frame and comprising
an insert groove in the longitudinal direction adapted to receive an insert,
an engagement formation in the longitudinal direction along the insert groove,
wherein the engagement formation is designed to interact with a locking member to allow interconnection between the holder and the insert, and wherein the locking member is a separate component, which is detachable from or connected by means of a pivot joint to the holder.

8. A holder according to claim 7, wherein the locking member is of a snap-in type, which may assume a locking position by applying a force in a first direction such that the structure of the locking member passes a dead-centre position and the locking member maintains the locking position until a force in an opposite direction brings the locking member back to a releasing stage.

9. A holder according to claim 7, comprising a locking member, wherein the locking member is formed with a hook shaped portion and the engagement formation of the holder is in form of a pivot joint such that the locking member is pivotally connected to the holder and capable of engaging an engagement formation of the insert by means of the hook shaped portion.

10. A holder according to claim 9, wherein the pivot joint comprises a link member, which at one edge is rotatably connected to the holder and at the other edge to the locking member and which defines a dead-centre position for the locking member such that when the hook shaped portion is in engagement with the engagement formation of the insert and the rotatable connection to the locking member is at one side of the dead-centre position, the locking member locks the insert to the holder, whereas when the rotatable connection of the locking member is at the other side of the dead-centre position, the insert is releasable from the holder.

11. A holder according to claim 7, wherein the holder also is provided with a second engagement formation along the other edge of the insert groove, in relation to the locking member, wherein the second engagement formation of the holder is capable of going into engagement with a complementary engagement formation of the insert when assembling them in an angled position in relation to the fully mounted position.

12. An insert unit for a metering device for coating liquid or viscous coating medium onto a moving material web, comprising an insert and a coating rod, the insert being elongated and comprising
a rod groove in the longitudinal direction, being adapted to rotatably support a coating rod having a circular cross section and being designed to surround the coating rod over more than 180° of its circumference, and
an engagement formation in the longitudinal direction along the rod groove, wherein the engagement formation is designed to interact with a locking member to allow interconnection between the insert and a holder of the metering device, wherein the locking member is a separate component, which is detachable from or connected by means of a pivot joint to the holder, and wherein the coating rod is rotatably accommodated in the rod groove of the insert.

13. An insert unit according to claim 12, wherein the locking member is of a snap-in type, which may assume a locking position by applying a force in a first direction such that the structure of the locking member passes a dead-centre position and the locking member maintains the locking position until a force in an opposite direction brings the locking member back to a releasing stage.

14. An insert unit according to claim 12, wherein the insert also is provided with a second engagement formation along the other edge of the rod groove, in relation to the locking member, wherein the second engagement formation of the insert is capable of going into engagement with a complementary engagement formation of the holder when assembling them in an angled position in relation to the fully mounted position.

15. An insert unit according to claim 12, wherein the insert is at least limitedly resilient to allow opening of the rod groove for allowing insertion of the coating rod into the rod groove.

16. An insert for a metering device for coating liquid or viscous coating medium onto a moving material web, the insert being elongated and comprising
a rod groove in the longitudinal direction, being adapted to rotatably support a coating rod having a circular cross section and being designed to surround the coating rod over more than 180° of its circumference,
an engagement formation in the longitudinal direction along the rod groove,
and wherein the engagement formation is designed to interact with a locking member to allow interconnection between the insert and a holder of the metering device, wherein the locking member is a separate component, which is detachable from or connected by means of a pivot joint to the holder.

17. An insert according to claim 16, wherein the locking member is of a snap-in type, which may assume a locking position by applying a force in a first direction such that the structure of the locking member passes a dead-centre position and the locking member maintains the locking position until a force in an opposite direction brings the locking member back to a releasing stage.

18. An insert according to claim 16, wherein the insert also is provided with a second engagement formation along the other edge of the rod groove, in relation to the locking member, wherein the second engagement formation of the insert is capable of going into engagement with a complementary engagement formation of the holder when assembling them in an angled position in relation to the fully mounted position.

19. An insert according to claim 16, wherein the insert is at least limitedly resilient to allow opening of the rod groove for allowing insertion of the coating rod into the rod groove.

20. A metering device for coating liquid or viscous coating medium onto a moving material web, comprising a holder unit according to claim 1.

21. A metering device for coating liquid or viscous coating medium onto a moving material web, comprising a holder according to claim 7.

22. A metering device for coating liquid or viscous coating medium onto a moving material web, comprising an insert unit according to claim 12.

23. A metering device for coating liquid or viscous coating medium onto a moving material web, comprising an insert according to claim 16.
